(19) United States
(12) Patent Application Publication
(10) Pub. No.: US 2005/0217305 A1
(43) Pub. Date: Oct. 6, 2005

(54) Refrigerator

(75) Inventors: Ho Sang Park, Gwangju-City (KR); Gi Joong Jeong, Gwangju-City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/028,659

(22) Filed: Jan. 5, 2005

(30) Foreign Application Priority Data
Mar. 30, 2004 (KR) 2004-21501

(51) Int. Cl. B67D 5/62

(52) U.S. Cl. 62/389

(57) ABSTRACT

A refrigerator including improved shelves that are capable of being rapidly assembled and disassembled and providing an aesthetically beautiful appearance. To both sides of each shelf are attached a pair of supporting members. To both sides of a storage compartment are attached a pair of frames. Each supporting member includes a first fixing protrusion and a second fixing protrusion, which are inserted through a first fixing hole and a second fixing hole formed at each frame, respectively. The first fixing protrusion includes an insertion part extended from the upper end of the supporting member, the insertion part being inserted through the first fixing hole, and a hooking part extended downward from the insertion part, the hooking part being caught in the first fixing hole. To the first and second fixing protrusions is attached a reinforcing member for increasing the supporting strength of the supporting member.

### BACKGROUND OF THE INVENTION

1. Field of the Invention

The present invention relates to a refrigerator, and, more particularly, to a refrigerator including improved shelves mounted to a freezer compartment and a refrigerator compartment of the refrigerator, whereby the shelves are rapidly assembled and disassembled, and an aesthetically beautiful appearance of the refrigerator is also provided.

2. Description of the Related Art

A refrigerator is an apparatus for supplying cool air generated from an evaporator to a freezer compartment and a refrigerating compartment so that various kinds of food are freshly stored for a long period of time. In the freezer compartment is stored food, such as meat, which is to be maintained below a freezing temperature. In the refrigerator compartment is stored food, such as vegetables and fruits, which is to be freshly maintained at a temperature slight higher than the freezing temperature.

In the freezing and refrigerating compartments, which are divided by means of an intermediate partition, are disposed horizontally a plurality of shelves for conveniently storing a large amount of food. To both sides of each shelf are attached brackets, by means of which the shelf is mounted in the freezing and refrigerating compartments. To both sides of the rear wall of the storage compartment are fixed frames, with which the brackets are fixedly engaged.

Each bracket attached to both sides of the shelf is attached to each frame fixed to the rear wall of the storage compartment. Consequently, the shelf is supported so that food is stored on the shelf. It is required that the strength of the bracket, especially, the strength of the part where the bracket is attached to the frame be larger than a prescribed strength in order to store food on the shelf.

In the conventional refrigerator, however, the vertical height of the bracket attached to the frame is large so that the strength of the bracket is above the prescribed strength. As a result, the whole size of the bracket is inevitably increased. Consequently, the disassembly and assembly operation is troublesome, and thus the time necessary to assemble the shelf is increased. Furthermore, the bracket, which has a big size after assembly, injures the aesthetically beautiful appearance of the refrigerator.

### SUMMARY OF THE INVENTION

Therefore, it is an aspect of the invention to provide a refrigerator including improved shelves that are capable of being rapidly assembled and disassembled and providing an aesthetically beautiful appearance.

In accordance with one aspect, the present invention provides a refrigerator comprising: at least one storage compartment; at least one shelf disposed in the storage compartment; a supporting member provided at the shelf; a frame fixed to the storage compartment, the supporting member being attached to the frame; and a reinforcing member attached to the supporting member.

The supporting member includes a first fixing protrusion and a second fixing protrusion, and the frame is provided with a first fixing hole and a second fixing hole, the first and second fixing protrusions being inserted through the first and second fixing holes, respectively.

Preferably, the reinforcing member is attached to the first and second fixing protrusions of the supporting member.

Preferably, the reinforcing member has the same shape as that of the first and second fixing protrusions.

Preferably, the reinforcing member is attached to the supporting member by means of welding.

The first fixing protrusion is formed at the upper end of the supporting member while the second fixing protrusion is formed at the lower end of the supporting member, and the first and second fixing holes are spaced apart from each other by a distance corresponding to the distance between the first and second fixing protrusions.

The first fixing protrusion includes an insertion part extended horizontally from the supporting member, the insertion part being inserted through the first fixing hole, and a hooking part extended downward from the insertion part, the hooking part being caught in the first fixing hole, and the supporting member further includes an insertion groove formed between the insertion part and the hooking part, the insertion groove having a width corresponding to the thickness of the frame.

The first fixing hole has a vertical length larger than that of the first fixing protrusion so that there is formed a prescribed gap between the upper end of the first fixing protrusion and the first fixing hole while the first fixing protrusion is inserted through the first fixing hole.

The second fixing protrusion is extended horizontally from the lower end of the supporting member by a length smaller than that of the first fixing protrusion so that the second fixing protrusion is inserted through the second fixing hole.

The supporting member comprises a pair of supporting members extended downward from both sides of the shelf, respectively, and the frame comprises a pair of frames disposed vertically from both sides of the rear wall of the storage compartment, respectively.

### BRIEF DESCRIPTION OF THE DRAWINGS

FIG. 1 is a perspective view of a refrigerator according to a preferred embodiment of the present invention;

FIG. 2 is an exploded perspective view showing the attachment of a shelf shown in FIG. 1 to frames disposed at the rear wall of the refrigerator;

FIG. 3 is an exploded perspective view, in part, showing the shelf shown in FIG. 2; and

FIG. 4 is an assembled perspective view, in part, showing the shelf shown in FIG. 2.

### DETAILED DESCRIPTION OF THE PREFERRED EMBODIMENTS

A preferred embodiment of the present invention will now be described in detail with reference to the accompanying drawings.

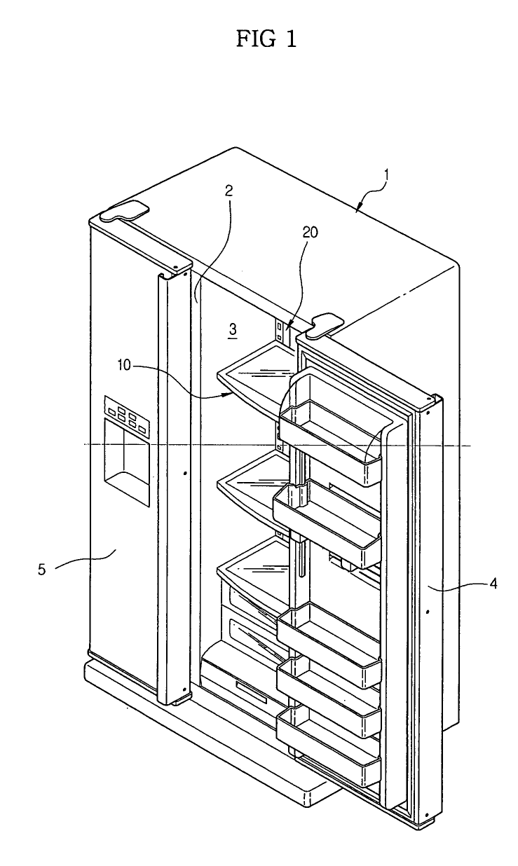

FIG. 1 is a perspective view of a refrigerator according to a preferred embodiment of the present invention. As shown in FIG. 1, the refrigerator according to the present invention comprises: a cabinet 1 formed in the shape of a box with an open front part; a freezer compartment (not shown) and a refrigerator compartment 3 provided in the left and right sides of the cabinet 1, respectively, the freezer and refrigerator compartments being divided by means of an intermediate partition 2 vertically disposed in the cabinet 2; and a freezer compartment door 4 and a refrigerator compartment door 5 hinged at the front parts of the freezer compartment and the refrigerator compartment 3 for closing the freezer compartment and the refrigerator compartment 3, respectively. Consequently, the inside space of the cabinet 1 is partitioned in the lateral direction of the refrigerator. It is also possible that the intermediate partition 2 is disposed horizontally inside the cabinet 1. In this case, the inner space of the cabinet 1 is partitioned in the vertical direction of the refrigerator so that the freezer compartment and the refrigerator compartment 3 are disposed at the upper and lower parts of the cabinet 1, respectively.

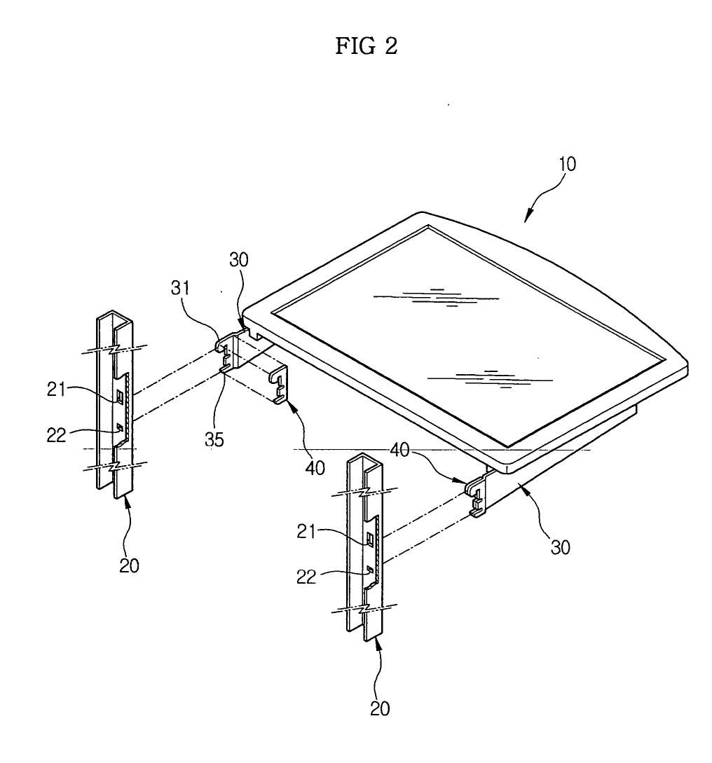

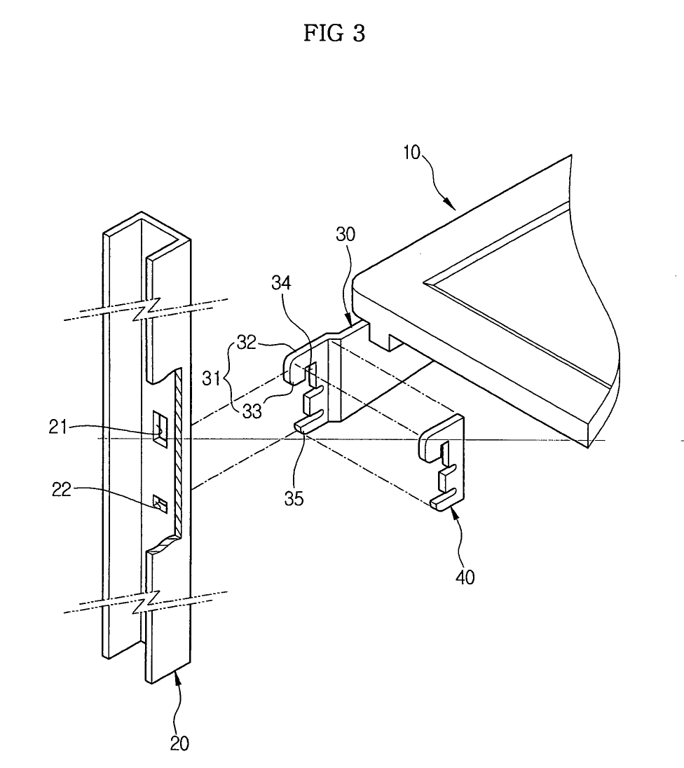

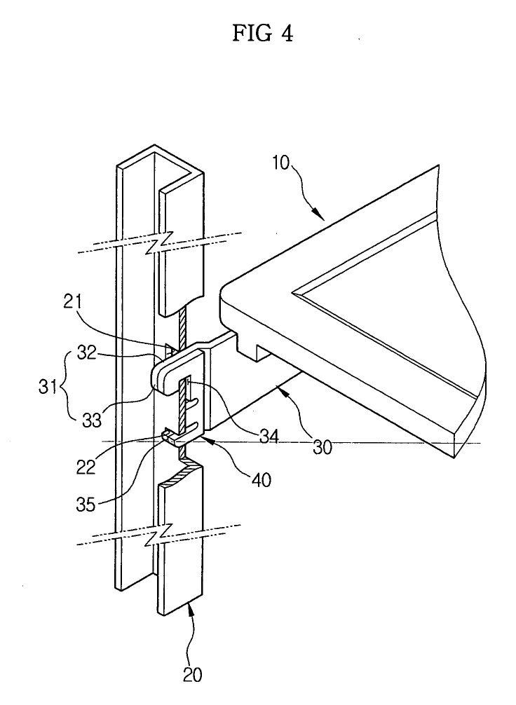

In the freezer compartment and the refrigerator compartment 3 (hereinafter, referred to as “storage compartment”) are horizontally disposed a plurality of shelves 10 in such a manner that the shelves 10 are arranged one above another so that a large amount of food is conveniently stored on the shelves 10. The shelves 10 are fixedly attached to a pair of frames 20 disposed vertically at both sides of the rear wall of the storage compartment 3. The attachment of each shelf 10 to the frames 20 will hereinafter be described with reference to FIGS. 2 to 4. FIG. 2 is an exploded perspective view showing the attachment of a shelf shown in FIG. 1 to frames disposed at the rear wall of the refrigerator, FIG. 3 is an exploded perspective view, in part, showing the shelf shown in FIG. 2, and FIG. 4 is an assembled perspective view, in part, showing the shelf shown in FIG. 2.

To both sides of the shelf 10 are fixed a pair of supporting members 30, by means of which the shelf 10 is mounted to the frames 20.

Each supporting member 30 is vertically extended from both sides of the shelf 10 in such a manner that the vertical length of the supporting member 30 is decreased from the rear end to the front end of the shelf 10. It is also possible that each supporting member 30 has the same vertical length from the rear end to the front end of the shelf 10. The supporting member 30 may be integrally formed with the shelf 10, or otherwise the supporting member 30 may be separately made from the shelf 10 so that the supporting member 30 is fixed to the shelf 10.

At the rear end of the supporting member 30 are integrally formed a first fixing protrusion 31 and a second fixing protrusion 35, while the first and second fixing protrusions 31 and 35 are extended toward the frame 20, by means of which the supporting member 30 are fixed to the frame 20. At the frame 20 are formed a first fixing hole 21 and a second fixing hole 22, through which the first fixing protrusion 31 and the second fixing protrusion 35 are fixedly inserted, respectively.

To the inner side of each supporting member 30, where the first and second fixing protrusions 31 and 35 are formed, is attached a reinforcing member 40 for reinforcing the strength of the supporting member 30, more particularly, the strength of the first and second fixing protrusions 31 and 35 fixed to the frame 20.

As shown in FIGS. 3 and 4, the first and second fixing protrusions 31 and 35 are extended by a prescribed length from the rear end of the supporting member 20 so that the first and second fixing protrusions 31 and 35 are fixedly inserted through the first and second fixing holes 21 and 22 of the frame 20, respectively.

The first fixing protrusion 31 formed at the upper rear end of the supporting member 30 includes an insertion part 32 extended horizontally from the supporting member 30, and a hooking part 33 extended downward from the insertion part 32. Between the insertion part 32 and the hooking part 33 is formed an insertion groove 34, which is opened downward and has a width corresponding to the thickness of the frame 20 at which the first and second fixing holes 21 and 22 are formed.

The vertical length of the first fixing hole 21 is slightly larger than the vertical length of the first fixing protrusion 31 from the upper end of the insertion part 32 to the lower end of the hooking part 33 so that the first fixing protrusion 31 including the insertion part 32 and the hooking part 33 is easily inserted through and separated from the first fixing hole 21 of the frame 20.

The second fixing protrusion 35 formed at the lower rear end of the supporting member 30 while being spaced a prescribed distance from the first fixing protrusion 31 is formed such that the horizontally extended length of the second fixing protrusion 35 is slightly smaller than that of the first fixing protrusion 31. The vertical length of the second fixing hole 21, through which the second fixing protrusion 35 is inserted, is slightly larger than that of the second fixing protrusion 35 so that the second fixing protrusion 35 is moved slightly upward along with the first fixing protrusion 31.

The reinforcing member 40 is formed in the same shape as the first and second fixing protrusions 31 and 35 integrally formed at the rear end of the supporting member 30. The reinforcing member 40 is attached to the first and second fixing protrusions 31 and 35 by means of spot welding. It is also possible that the reinforcing member 40 is formed in a shape different from that of the first and second fixing protrusions 31 and 35. In this case, the reinforcing member 40 may be attached to the supporting member 30 by means of screws or other fixing elements.

Since the reinforcing member 40 is attached to the first and second fixing protrusions 31 and 35 as described above, the first and second fixing protrusions 31 and 35 are thicker than the other parts of the supporting member 30. Consequently, the strength of the first and second fixing protrusions 31 and 35 is improved.

The vertical length of the supporting member 30 at the rear end thereof can be decreased by means of the reinforcing member 40. Consequently, the total size of the supporting member 30 can be decreased with the result that attachment of the shelf 10 to the storage compartment 3 or separation of the shelf 10 from the storage compartment 3 is easily accomplished while the aesthetic appearance of the refrigerator is not spoiled.

Since the reinforcing member 40 is attached to the first and second fixing protrusions 31 and 35 as described above, the horizontal width of the first and second fixing holes 21 and 22 exactly corresponds to the sum of the thickness of the reinforcing member 40 and the thickness of the first and second fixing protrusions 31 and 35.

The assembly of the shelf 10 in the storage compartment 3 by the attachment of the supporting member 30 with the reinforcing member 40 fixed thereto to the frame or the disassembly of the shelf 10 from the storage compartment 3 is carried out as follows.

The first and second fixing protrusions 31 and 35 are inserted through the first and second fixing holes 21 and 22, respectively, while the front end of the shelf 10 is inclined upward so that the hooking part 33 of the first fixing protrusion 31 is inserted through the first fixing hole 21. Subsequently, the rear end of the shelf 10 is pushed downward so that the insertion groove 34 formed at the first fixing protrusion 31 is placed at the lower end of the first fixing hole 21. Consequently, the supporting member 30 is fixed to the frame 20 so that food is put and stored on the shelf 10.

When the front end of the shelf 10 is raised upward while the first and second fixing protrusions 31 and 35 are inserted through the first and second fixing holes 21 and 22, respectively, and thus the supporting member 30 is fixed to the frame 20, the first and second fixing protrusions 31 an 35 are moved slightly upward in the first and second fixing holes 21 and 22 so that the insertion groove 34 is separated from the lower end of the first fixing hole 21. Subsequently, the shelf 10 is pulled forward while the front end of the shelf 10 is raised upward with the result that the first and second fixing protrusions 31 and 35 are separated from the first and second fixing holes 21 and 22, respectively. Consequently, the shelf 10 is separated from the frame 20.

As apparent from the above description, the present invention provides a refrigerator including improved shelves with supporting members attached to frames wherein the supporting members are reinforced by means of reinforcing members, whereby the vertical length of each supporting member is decreased, and thus attachment and separation of the shelves are easily accomplished. Furthermore, the aesthetic appearance of the refrigerator is improved.

Although the preferred embodiment of the invention has been disclosed for illustrative purposes, those skilled in the art will appreciate that various modifications, additions and substitutions are possible, without departing from the scope and spirit of the invention as disclosed in the accompanying claims.

1. A refrigerator comprising:
at least one storage compartment;
at least one shelf disposed in the storage compartment;
a supporting member provided at the shelf;
a frame fixed to the storage compartment, the supporting member being attached to the frame; and
a reinforcing member attached to the supporting member.

2. The refrigerator according to claim 1, wherein the supporting member includes a first fixing protrusion and a second fixing protrusion, and wherein the frame is provided with a first fixing hole and a second fixing hole, the first and second fixing protrusions being inserted through the first and second fixing holes, respectively.

3. The refrigerator according to claim 2, wherein the reinforcing member is attached to the first and second fixing protrusions of the supporting member.

4. The refrigerator according to claim 3, wherein the reinforcing member has a similar shape as that of the first and second fixing protrusions.

5. The refrigerator according to claim 3, wherein the reinforcing member is welded to the supporting member.

6. The refrigerator according to claim 2, wherein the first fixing protrusion is formed at the upper end of the supporting member and the second fixing protrusion is formed at the lower end of the supporting member, such that the first and second fixing holes are spaced apart from each other by a distance that corresponds to the distance between the first and second fixing protrusions.

7. The refrigerator according to claim 6, wherein the first fixing protrusion includes an insertion part that is horizontally extended from the supporting member, the insertion part being inserted through the first fixing hole, and a hooking part extended downward from the insertion part, the hooking part being caught in the first fixing hole, and wherein the supporting member further includes an insertion groove formed between the insertion part and the hooking part, the insertion groove having a width corresponding to the thickness of the frame.

8. The refrigerator according to claim 7, wherein the first fixing hole has a vertical length that is larger than that of the first fixing protrusion so that a prescribed gap is formed between the upper end of the first fixing protrusion and the first fixing hole while the first fixing protrusion may be inserted through the first fixing hole.

9. The refrigerator according to claim 6, wherein the second fixing protrusion is horizontally extended from the lower end of the supporting member by a smaller length than that of the first fixing protrusion so that the second fixing protrusion may be inserted through the second fixing hole.

10. The refrigerator according to claim 1, wherein the supporting member comprises a pair of supporting members extended downward from both sides of the shelf, respectively, and wherein the frame comprises a pair of frames vertically disposed from both sides of the rear wall of the storage compartment, respectively.

11. A refrigerator comprising:
a cabinet having a freezer compartment and a refrigerator compartment defined therein;
a plurality of shelves disposed while being spaced a prescribed distance from each other in the freezer and refrigerator compartments;
a pair of supporting members disposed at both sides of each of the shelves;
a pair of frames disposed vertically from both sides of each of the rear walls of the freezer and refrigerator compartments; and
reinforcing members attached to the supporting members, respectively, to increase the supporting strength of the supporting members.

12. The refrigerator according to claim 11, wherein each of the supporting members includes a first fixing protrusion and a second fixing protrusion, the first and second fixing protrusions being vertically spaced apart from each other, and wherein each of the frames is provided with a first fixing hole and a second fixing hole, the first and second fixing protrusions being inserted through the first and second fixing holes, respectively.

13. The refrigerator according to claim 12, wherein the first fixing protrusion includes an insertion part that is extended horizontally from the upper end of the supporting member, the insertion part being inserted through the first fixing hole, and a hooking part that is extended downward from the insertion part, the hooking part being caught in the first fixing hole, and wherein the second fixing protrusion is extended horizontally from the lower end of the supporting member by a smaller length than that of the insertion part so that the second fixing protrusion is inserted through the second fixing hole.

14. The refrigerator according to claim 13, wherein the first fixing hole has a vertical length that is larger than that of the first fixing protrusion so that the first fixing protrusion is easily inserted through and separated from the first fixing hole.

15. The refrigerator according to claim 13, wherein each of the reinforcing members is attached to the first and second fixing protrusions of each the supporting members to increase the supporting strength of the first and second fixing protrusions.

16. A refrigerator including at least one storage compartment and at least one shelf disposed in the storage compartment, the refrigerator comprising:
a supporting member to support the shelf with a supporting strength;
a frame fixed to the storage compartment, the supporting member being attached to the frame such that the supported shelf has an edge that is adjacent to the frame relative to the remaining edges of the frame; and
a reinforcing member attached to the supporting member to increase the supporting strength of the supporting member.

17. The refrigerator according to claim 16, wherein the supporting member comprises a pair of supporting members fixed to sides of the shelf.

18. The refrigerator according to claim 17, wherein the supporting members have a tapered height, as measured from the shelf, that is greater at the edge of the shelf that is adjacent to the frame.

19. The refrigerator according to claim 17, wherein the supporting members have a constant height measured from the shelf.

20. The refrigerator according to claim 17, wherein the supporting members each comprise first and second fixing protrusions, integrally formed at the edge of the shelf that is adjacent to the frame, to protrude toward the frame.

21. The refrigerator according to claim 20, further comprising pairs of first and second fixing holes in the frame through which the first and second protrusions may be fixedly inserted, the first fixing holes each including a lower edge.

22. The refrigerator according to claim 21, wherein each of the first fixing protrusions comprise:
an insertion part extended horizontally from each supporting member to extend through the first fixing hole;
a hooking part extended downward from the insertion part; and
an insertion groove formed in the space defined the insertion part, the hooking part, and the supporting member into which the lower edge of the first fixing hole is inserted.

23. The refrigerator according to claim 22, wherein each of the insertion grooves are opened downward and have widths that correspond to the thickness of each of the lower edges of the first fixing holes.

24. The refrigerator according to claim 23, wherein each of the first fixing holes has a vertical length that is a slightly larger than a vertical length from an upper edge of each of the insertion parts to a lower edge of each of the hooking parts.

25. The refrigerator according to claim 21, wherein each of the second fixing protrusions are formed at lower ends of the edge of the supporting member that is to be adjacent to the frame and are separated from the first protrusion.

26. The refrigerator according to claim 25, wherein each of the second fixing protrusions comprise a horizontal member having a horizontal length that is sufficient to allow the horizontal member to extend through the second fixing holes of the frame when the first fixing protrusions are coupled to the first fixing holes.

27. The refrigerator according to claim 26, wherein the vertical length of each of the second fixing holes through which the second fixing protrusions are inserted is slightly larger than that of each of the second fixing protrusions.

28. The refrigerator according to claim 21, wherein the first and second fixing protrusions each are shaped so as to allow the first and second fixing protrusions to cooperate with the first and second fixing holes, respectively, and each of the reinforcing member has a substantially similar shape as that of the first and second fixing protrusions.

29. The refrigerator according to claim 28, wherein the reinforcing member is spot welded to the first and second protrusions.

30. The refrigerator according to claim 29, wherein the cross sectional area of the first and second protrusions and the reinforcing member is greater than that of any remaining sections of the supporting member.

31. The refrigerator according to claim 21, wherein each of the first and second fixing protrusions have a shape to allow the first and second fixing protrusions to cooperate with the first and second fixing holes, respectively, and each of the reinforcing member is screwed onto the first and second protrusions.
